(19) United States
(12) Patent Application Publication
(10) Pub. No.: US 2014/0278484 A1
(43) Pub. Date: Sep. 18, 2014

(54) PATIENT CONSENT FORM WITH VOICE MODULE

(71) Applicant: Shairko MISSOURI, Jersey Shore, PA (US)

(72) Inventor: Shairko MISSOURI, Jersey Shore, PA (US)

(21) Appl. No.: 14/155,789

(22) Filed: Jan. 15, 2014

Related U.S. Application Data
(60) Provisional application No. 61/790,188, filed on Mar. 15, 2013.

(51) Int. Cl. G06Q 50/22; G10L 17/00

(52) U.S. Cl. CPC G06Q 50/22; G10L 17/00
USPC 705/2

(57) ABSTRACT

A medical consent form includes a written consent portion having one or more form fields regarding consent of a patient to a medical procedure marked thereon. The written consent portion is marked on a material suitable for writing by a writing instrument. A voice recorder module is embedded in the material. An actuator is coupled to the voice recorder to cause the voice recorder module to record the patient's voice consent. Prior to a medical procedure, the patient records information regarding the medical procedure using the voice recorder module. The information in the recording is compared with other written information in the operating theater to confirm the proper medical procedure is being performed on a proper consenting patient.

### CROSS-REFERENCE TO RELATED APPLICATIONS

This application claims the benefit of U.S. Provisional Application No. 61/790,188, filed Mar. 15, 2013.

### BACKGROUND OF THE INVENTION

Mistakes made during medical procedures, and particularly during surgery, can be costly to patients, to medical professionals, and to medical organizations providing services. Such mistakes may include performing a correct procedure on an incorrect site, performing a correct procedure on the wrong patient, and performing the wrong type of procedure. These mistakes can result in irreversible emotional and physical damage to the patient, as well as costly litigation for the healthcare professionals. Therefore, avoiding such mistakes is of paramount importance in the healthcare profession.

One procedure used by healthcare professionals to minimize such mistakes is the use of a surgical consent form. The surgical consent form, which is signed by the patient or legal representative, provides information about the procedure to be performed. By signing the form, the patient is acknowledging that he or she is consenting to the procedure detailed on the form, which generally includes information such as the patient's name, the date and time of the medical procedure, the type of medical procedure, and the location of the medical procedure.

Another procedure used by healthcare professionals to minimize mistakes is the use of a surgical time out during surgical operations and procedures. The surgical time out, which typically occurs immediately before starting an invasive procedure or making an incision, is intended to slow down the medical staff to allow consideration and confirmation of the procedure they are about to perform. As part of the surgical time out, a plurality of steps are typically taken by a member of the medical team, as laid out by the Joint Commission Universal Protocol Guidelines. Such steps include, at a minimum, confirming (i) correct patient identity; (ii) correct site; and (iii) correct procedure to be performed. The data on the patient's consent form is verified as a part of this surgical timeout.

The effectiveness of the surgical timeout, however, depends on the members of the medical team properly reviewing the consent form, the orders, and the patient. The patient, who typically has been anesthetized or deeply sedated by this time, cannot generally provide confirmation of the information described during the surgical timeout.

Accordingly, it is desirable to further reduce the possibility of mistakes during medical procedures by obtaining a recorded message of the patient prior to beginning the procedure, which may be used prior to the medical procedure to assist in confirming the proper procedure is being performed. It is further desirable to provide a consent form to facilitate this process.

### BRIEF SUMMARY OF THE INVENTION

In one embodiment, a medical consent form is described. A medical consent form includes a written consent portion having one or more form fields regarding consent of a patient to a medical procedure marked thereon. The written consent portion is marked on a material suitable for writing by a writing instrument. A voice recorder module is embedded in the material. An actuator is coupled to the voice recorder to cause the voice recorder module to record the patient's voice consent. Prior to a medical procedure, the patient records information regarding the medical procedure using the voice recorder module. The information in the recording is compared with other written information in the operating theater to confirm the proper medical procedure is being performed on a proper consenting patient.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is an diagram of an exemplary prior art patient consent form;

FIG. 2 is a diagram of an exemplary patient consent form having a voice recorder module according to preferred embodiments of the present invention;

FIG. 3 is an exemplary system diagram of the voice recorder module of FIG. 2; and

FIG. 4 is a flow chart of a method of using a consent form with voice recorder module.

### DETAILED DESCRIPTION OF THE INVENTION

Certain terminology is used in the following description for convenience only and is not limiting. The words “lower,” “bottom,” “top” and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, FIG. 1 is an exemplary patient consent form 100 used to receive a patient's informed consent prior to a medical procedure or operation. Typically, patient consent forms 100 may be a single sheet, or may include one or more sheets of carbon copy or other paper bound together. One or more statements and/or questions 110 regarding the procedure and the patient are printed on the consent form 100. The questions and statements 110 provide information regarding the patient and the procedure, and risks thereof. The patient, a legal representative, or a medical professional (e.g., nurse, doctor, physician assistant) fills out part or all of the consent form with the patient's information such as the patient's name, the date, and a description of the procedure. The patient or legal representative reviews and signs the form on a signature block 112 to provide the consent. Consent generally must be provided prior to commencing the procedure.

As shown in FIG. 2, a modified patient consent form 200 includes a similar questions and statements area 210 printed or otherwise marked on one or both sides of the patient consent form 200. Preferably, the patient consent form 200 is constructed from at least two layers of a material such as heavy duty cardstock, cardboard, or the like. The patient or legal representative may still review and sign the form on a signature block 212 to provide the consent.

A voice recorder module 220 is embedded within the layers of the patient consent form 200. An actuator 230 is coupled to the voice recorder module 220. The actuator 230 is preferably embedded in the surface of the patient consent form 200 such that a user may depress, switch, or otherwise activate the actuator 230 without damaging the patient consent form 200 during the actuation.

The voice recorder module 220 may be any recording module capable of recording and playing back human voice input. Preferably, the voice recorder module can record for a sufficient length of time to allow a patient to describe in detail their identity, and appearance, if desired, and the procedure they are consenting to undergo. Accordingly, it is contemplated that a minute or more of human voice recording may need to be stored by the voice recorder module 220.

As shown in FIG. 3, the voice recorder module 220 preferably includes a voice IC 222. The voice IC 222 receives sound input from a microphone 228, and stores the sound input on a memory (e.g., flash memory or the like) embedded in the voice IC 222. In alternative embodiments, a separate memory module (not shown) may be coupled to the voice IC 222 in order to provide more advanced features. The voice IC 222 outputs recorded sound to a speaker 226 for playback. A battery 224 provides power for the voice IC 222, the microphone 228, and the speaker 226, as needed. The voice recorder optionally includes an external interface 250.

In operation, a user depresses the actuator 230 of a new patient consent form 200 to begin recording by the voice recorder module 220. Preferably, each voice recorder module 220 may only be actuated to record once, after which the recording is stored by the voice IC 222, and cannot be overwritten. The voice recording may be played back multiple times over the speaker 226. Accordingly, while the first actuation of the actuator 230 causes the voice IC 222 to activate the microphone 228 to record sound input, each additional actuation of the actuator 230 causes the voice IC 222 to play back the recorded sound input through the speaker 226. While in the preferred embodiment, sound may only be recorded once, in other embodiments, the voice recorder module 220 may allow overwriting the recorded sound multiple times to allow a patient to perfect or correct the voice consent recording. In other embodiments, the voice recorder may present one or more audio prompts to the user indicating the type of information that should be spoken, such as the patient's name, a description of the patient's appearance, a description of the medical procedure to be performed, or the site of the medical procedure.

In order to improve usability of the patient consent form 200, in some embodiments, the actuator 230 may be divided into two or more distinct actuators, with each actuator configured to enable a particular function. For example, the play and record functions may be split between two distinct actuators 230. Furthermore, one or more indicators (e.g., LEDs) may be coupled to the voice recorder module 220 to provide feedback to the user regarding the operation being performed by the voice recorder module 220. For example, a red LED may be lit up or blink when the voice recorder module 220 is recording.

Preferably, a patient records the patient's name and/or distinctive physical features, date of birth, other identifying information such as social security number, and describes the procedure (e.g., type of procedure, location of procedure, surgeon, operating room, anesthesiologist) to be performed. Together with the recording of the voice consent on the patient consent form 200, the patient (or another authorized individual) also fills out the form 210 of the patient consent form and signs the signature block 212 as in the prior art patient consent form 100.

The recorded audio consent of the patient consent form 200 is preferably played by procedure staff during the surgical timeout or other time prior to surgery to confirm, in the patient's own words, that the correct procedure is being performed at the correct site, and on the correct patient. After the procedure, the patient consent form 200 may scanned and filed in order to be archived in patient's medical record. The original hardcopy of the patient consent form 200 with the recording device 220 is kept either in the patient chart, or it may be discarded as per the health care provider's privacy requirement. In the preferred embodiment, there is no need for the audio consent to be maintained for later use, as the written consent will be maintained as proof of the consent. That is, the preferred goal of using the audio consent is to confirm the information written in the patient consent form 200. Therefore when the procedure is completed, the benefit and objective of the audio have been achieved, and the audio recording may no longer be needed. However, in other embodiments, a policy or law may require the maintaining of the audio consent for a period of time. In this case, the voice recorder module 220 should be selected to ensure that the data storage requirements of the policy are met. That is, if a policy requires that patient audio data be encrypted, a voice IC 222 with encryption capabilities should be used.

In some embodiments, the voice recorder module may have an external interface 250 coupled to the voice IC 222. The external interface 250 allows the audio recorded by the voice IC 222 to be output to an external device (not shown). In one embodiment, the external interface 250 is a 802.11 Wi-Fi adapter which outputs the audio recording in a format such as WAV or MP3 to an electronic medical record (EMR) system maintained on a computer or server system (not shown) at the facility or a remote location. In this case, each patient consent form 200 is preferably assigned a unique serial number, and the unique serial number is encoded in the voice IC 222 such that the serial number is output together with the audio recording to the EMR system to identify the patient record with which the consent should be associated.

In another embodiment, the external interface 250 may be a Bluetooth or other short-range communication adapter to allow audio recorded by the networked voice recorder module 220 to be played back on an external audio system (not shown) at the facility. Thus, for example, built-in speakers in an operating room may play the patient's consent audio such that it can be easily heard by all staff members involved in performing the consented procedure. Similarly, in some embodiments, the external interface 250 may allow the patient consent form 200 to be used to record and/or transmit an audio consent to a data storage at a remote location, such as an EMR server via a communications protocol such as Wi-Fi, BLUETOOTH, or the like.

In other embodiments, audio recording software (not shown) may be used simultaneously on a facility computer, mobile device, or the like to record the patient's consent simultaneously with the voice recorder module 220. The voice consent recorded by the audio recording software may then be attached to patient data in the EMR system in addition to the hard copy audio consent stored by the voice recorder module 220 of the patient consent form 200.

FIG. 4 is a flow chart of a method of using the consent form with voice recorder to prevent medical errors. At 410, the patient is presented with the consent form. The patient may perform some or all of the functions performed for a normal paper consent form, but additionally record voice data. The consent form may have a script for the patient to read, either with pre-filled data regarding the patient and the procedure to be confirmed by the patient, or with blanks for the patient to fill in while reading based upon his or her own knowledge. As described above, pressing of an actuator on the consent form may cause visual or audio prompts to be presented to the patient to speak particular types of information, such as name, appearance, expected medical procedure, and the site of the medical procedure.

At 420, the patient is moved to the operating theater. The operating theater may be a surgical room or other venue in which a medical procedure may be performed. After being moved to the operating theater, the patient may be sedated prior to use of the consent form for verification of the procedure.

At 430, the voice recorder of the consent form is used to play back at least some of the audio recorded by the patient.

At 440, medical staff compares the information from the audio playback with information regarding the procedure that is planned to be performed. Separate written documentation regarding the procedure to be performed may be made available in the operating theater for use in the comparison. Medical staff may also compare information on the consent form, such as a patient ID, with information on a patient identifier, such as a bracelet, to confirm that the proper consent form with voice recorder has accompanied the patient.

If at 440 the information played back from the patient recording matches the information expected by the medical personnel, the medical procedure may commence at 450. If there is a mismatch, the procedure is preferably halted at 460 until the source of the discrepancy can be determined and corrected.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims. For instance, combined audio and video recording may be substituted for audio recording. It will also be understood by one skilled in the art that the described method may be performed with other computing hardware in addition to the described consent form with voice recorder within the scope of the invention.

I claim:

1. A method for verifying consent to a medical procedure using a consent form comprising a voice recording module, comprising:
recording a patient recitation of information regarding the medical procedure using the voice recording module of the consent form;
relocating the patient to an operating theater;
playing, at the operating theater, the patient recitation of information regarding the medical procedure from the voice recording module of the consent form;
comparing, at the operating theater, the patient recitation of information regarding the medical procedure played from the voice recording module of the consent form and a written description of the planned medical procedure separate from the consent form; and
responsive to a determination, at the operating theater, that the patient recitation of information regarding the medical procedure played from the voice recording module of the consent form and the written description of the planned medical procedure separate from the consent form match, performing the medical procedure.

2. The method of claim 1 wherein patient recitation of information regarding the medical procedure comprises a description of the procedure to be performed.

3. The method of claim 1 wherein patient recitation of information regarding the medical procedure comprises a description of the site at which the medical procedure is to be performed.

4. The method of claim 1 further comprising, prior to playing, at the operating theater, the patient recitation of information regarding the medical procedure from the voice recording module of the consent form:
sedating the patient.

5. The method of claim 1 further comprising:
obtaining a patient signature on the consent form comprising a voice recording module.

6. The method of claim 1 wherein performing said medical procedure is further responsive to determining that a patient identifier on the consent form matches a patient identifier on an article attached the patient.

7. The method of claim 6 wherein the article attached the patient is a bracelet.

8. A medical consent form comprising:
a written consent portion having one or more form fields regarding consent of a patient to a medical procedure marked thereon, the written consent portion being marked on a material suitable for writing by a writing instrument;
a voice recorder module embedded in the material; and
an actuator integral to or coupled to the voice recorder causing the voice recorder module to record the patient's voice in response to an actuation of the actuator.

9. The medical consent form of claim 8 wherein the voice recorder module includes an integrated circuit, a microphone, a speaker, and a battery.

10. The medical consent form of claim 8 wherein the written consent portion comprises a printed script comprising at least a portion of a consent statement to be recorded by the patient.

11. The medical consent form of claim 8 wherein the voice recorder module records the patient's voice in response to the actuator being actuated for the first time.

12. The medical consent form of claim 11 wherein the voice recorder module outputs the recorded voice consent in response to a subsequent actuation of the actuator.

13. The medical consent form of claim 8 wherein the voice recorder module further includes a wired or wireless external interface.

14. The medical consent form of claim 8 wherein the voice recorder module is embedded between two layers of the material of the written consent portion.

15. The medical consent form of claim 8 wherein the material of the written consent portion is cardstock.

16. The medical consent form of claim 8 wherein the actuator is accessible to be actuated by a patient on a surface of the material of the written consent portion.

17. The medical consent form of claim 8 wherein said voice recorder module performs at least one of: presenting an audio prompt to the patient to record the patient's name, presenting an audio prompt to the patient to record a description of the patient's appearance, presenting an audio prompt to the patient to record a description of the medical procedure to be performed, and presenting an audio prompt to the patient to record the site of the medical procedure.

18. The medical consent form of claim 8, further comprising:
separate actuators for recording and playback.

19. The medical consent form of claim 8, further comprising:
one or more indicators for providing feedback to the patient regarding the operation being performed by the voice recorder module.
